(19) United States
(12) Patent Application Publication
(10) Pub. No.: US 2013/0209629 A1
(43) Pub. Date: Aug. 15, 2013

(54) DYE STABILIZING PROCESS FOR KIWI

(71) Applicant: Denis Gustavo BERNDT BRICEÑO, Santiago (CL)

(72) Inventor: Denis Gustavo BERNDT BRICEÑO, Santiago (CL)

(21) Appl. No.: 13/841,664

(22) Filed: Mar. 15, 2013

Related U.S. Application Data
(63) Continuation-in-part of application No. PCT/IB2011/002423, filed on Oct. 13, 2011.
(60) Provisional application No. 61/638,052, filed on Apr. 25, 2012.
(60) Provisional application No. 61/405,623, filed on Oct. 21, 2010.

(51) Int. Cl. A23L 1/275

(52) U.S. Cl. CPC A23L 1/2753
USPC 426/240; 426/250

(57) ABSTRACT

A method for imparting color stability and textural stability to cut kiwi, which can be fresh, or optionally individually quick-frozen (IQF) treated, using several stages including cutting, alkalinization of the fruit pulp, infusion of soluble stabilizing agents by immersion in an alkaline solution of said stabilizing agents to give the necessary firmness and texture integrity, infusion of dyeing agents by immersion in an alkaline color solution, fixation of said color and stabilizing agents in an acidic solution that has been enriched with polyvalent cations, to preserve and extend the shelf life.

### FIELD OF THE INVENTION

This invention provides a method for the dyeing and stabilizing of kiwi through a series of steps and with the use of dyeing and stabilizing agents and auxiliaries to obtain a final product with a stable non-bleeding proper color, appropriate firmness and desirable organoleptic features that are able to withstand thermal or chemical processing, light and time and thus are suitable for its use in fruit products.

### BACKGROUND OF THE INVENTION

A strong loss of color and firmness takes place when kiwi fruit is canned and pasteurized under normal conditions. The natural magnesium chlorophyll is a very unstable pigment that fades quickly upon heating and consequently the heated fruit turns yellowish. The yellowish color is explained by the presence of carotenoids or xanthophylls that withstand the heating process. Also, during the heating process a great loss of firmness occurs, which can be explained mainly by the diffusion of the natural fruit stabilizing-thickening agents (vegetable gums) to the packing syrup. This explains why today canned kiwi pieces or slices are manufactured using unripe fruit. When unripe fruit is selected for preservation, important quality features including flavor are sacrificed in favor of firmness and pulp hardness.

After studying processes for coloring and stabilizing kiwi and other types of fleshy fruits, found a process is provided based on the use of stabilizing agents and natural colorants for preparing a stable, firm, non-bleeding naturally colored kiwi with natural texture and flavor. A stable product is obtained that withstands thermal and or chemical sterilization processes, light and time without the loss of color, texture and hardness or flavor.

### SUMMARY OF THE INVENTION

The present invention provides a process to obtain colored kiwi with a non-bleeding and stabilized color, with firmness, texture, and flavor, to be commercialized as a sensory desirable product.

The present invention provides a method for the stable coloration of kiwi, including ripe fleshy kiwi, without affecting the texture, and preferably with an improvement in texture, and at the same time achieving the necessary firmness, texture, flavor, natural appearance and attractive non-bleeding color to be commercialized as a sensory desirable fruit product. Preferably the kiwi is a sliced parts or cubed kiwi parts.

The present invention provides a method for the stabilizing the color of kiwi infused with a dyeing agent, to prevent loss of color and color bleeding during prolonged shelf storage, including storage at temperatures elevated above room temperature.

The present invention also provides for the use of a stabilizing agent to stabilize the color of a kiwi infused with a dyeing agent, to prevent loss of color and color bleeding during prolonged shelf storage, including storage at temperatures elevated above room temperature.

An aspect of the present invention includes a method for dyeing and stabilizing a kiwi portion, comprising the steps of: (a) immersing a kiwi portion into the following solutions: i) an alkaline solution containing a stabilizing agent, and infusing the stabilizing agent through the surface of the kiwi portion to a penetrating depth of at least up to 5 mm, typically at least 1 mm and up to 3 mm; ii) an alkaline solution containing a dyeing agent, and infusing the dyeing agent through the surface of the kiwi portion to a penetrating depth of at least up to 5 mm, typically at least 1 mm and up to 3 mm; and iii) an acid solution that has been enriched with an ion selected from at least one of a calcium ions and a polyvalent cation, to fixate at least a portion of the infused stabilizing agent and the infused dyeing agent; and (b) rinsing and storing the resulting kiwi portion.

Another aspect of the present invention includes a method for dyeing and stabilizing a kiwi portion, or a plurality of kiwi portions, comprising the steps of: (a) immersing a kiwi portion into an alkaline solution containing a stabilizing agent and a dyeing agent, and infusing the stabilizing agent and dyeing agent through the surface of the alkaline-treated kiwi portion to a penetrating depth of at least up to 5 mm, typically at least 1 mm and up to 3 mm; (b) immersing the alkaline-treated kiwi portion into an acid solution that has been enriched with an ion selected from at least one of a calcium ions and a polyvalent cation, to fixate the infused stabilizing agent and dyeing agent; and (c) rinsing and storing the resulting dye-stabilized kiwi portion.

Another aspect of the present invention includes a method for dyeing and stabilizing a kiwi portion, comprising the steps of: (a) immersing a kiwi portion in an alkaline solution containing a stabilizing agent, and infusing the stabilizing agent through the surface of the kiwi portion to a penetrating depth of at least up to 5 mm, typically at least 1 mm and up to 3 mm; (b) immersing the stabilizing agent-infused kiwi portion in an alkaline solution containing a dyeing agent, and infusing the dyeing agent through the surface of the kiwi portion to a penetrating depth of at least up to 5 mm, typically at least 1 mm and up to 3 mm; (c) immersing the stabilizing agent and dyeing agent-infused kiwi portion in an acid solution that has been enriched with an ion selected from at least one of a calcium ions and a polyvalent cation, to fixate at least a portion of the stabilizing agent and dyeing agent; and (d) rinsing and storing the resulting dye-stabilized kiwi portion.

Another aspect of the present invention includes a method for dyeing and stabilizing a kiwi portion, comprising the steps of (a) immersing a kiwi portion in an alkaline solution containing a dyeing agent, and infusing the dyeing agent through the surface of the kiwi portion to a penetrating depth of at least up to 5 mm, typically at least 1 mm and up to 3 mm; (b) immersing the dyeing agent-infused kiwi portion in an alkaline solution containing a stabilizing agent, and infusing the stabilizing agent through the surface of the kiwi portion to a penetrating depth of at least up to 5 mm, typically at least 1 mm and up to 3 mm; (c) immersing the stabilizing agent and dyeing agent-infused kiwi portion in an acid solution that has been enriched with an ion selected from at least one of a calcium ions and a polyvalent cation, to fixate at least a portion of the stabilizing agent and dyeing agent; and (e) rinsing and storing the resulting dye-stabilized kiwi portion.

An aspect of the present invention includes a method for dyeing and stabilizing a kiwi portion, or a plurality of kiwi portion, comprising the steps of: (a) immersing a kiwi portion in an alkaline solution containing a dyeing agent, and infusing the dyeing agent through the surface of the kiwi portion to a penetrating depth of at least up to 5 mm, typically at least 1 mm and up to 3 mm; (b) immersing the dyeing agent-infused kiwi portion into an acid solution that has been enriched with an ion selected from at least one of a calcium ions and a polyvalent cation, to fixate at least a portion of the infused dyeing agent, (c) immersing the dyeing agent-fixated kiwi portion into an alkaline solution to adjust the penetrated surface of the kiwi portion to an alkaline pH; (d) immersing the alkaline pH kiwi portion into an alkaline solution containing a stabilizing agent, and infusing the stabilizing agent through the surface of the kiwi portion to a penetrating depth of at least up to 5 mm, typically at least 1 mm and up to 3 mm; (e) immersing the stabilizing agent-infused kiwi portion into an acid solution that has been enriched with an ion selected from at least one of a calcium ions and a polyvalent cation, to fixate at least a portion of the infused stabilizing agent; and (f) rinsing and storing the resulting dye-stabilized kiwi portion.

An aspect of the present invention includes a method for dyeing and stabilizing a kiwi portion, or a plurality of kiwi portion, comprising the steps of (a) immersing a kiwi portion in an alkaline solution containing a stabilizing agent, and infusing the stabilizing agent through the surface of the kiwi portion to a penetrating depth of at least up to 5 mm, typically at least 1 mm and up to 3 mm; (b) immersing the stabilizing agent-infused kiwi portion into an acid solution that has been enriched with an ion selected from at least one of a calcium ions and a polyvalent cation, to fixate at least a portion of the infused stabilizing agent, (c) immersing the stabilizing agent-fixated kiwi portion into an alkaline solution to adjust the penetrated surface of the kiwi portion to an alkaline pH; (d) immersing the alkaline pH kiwi portion into an alkaline solution containing a dyeing agent, and infusing the dyeing agent through the surface of the kiwi portion to a penetrating depth of at least up to 5 mm, typically at least 1 mm and up to 3 mm; (e) immersing the dyeing agent-infused kiwi portion into an acid solution that has been enriched with an ion selected from at least one of a calcium ions and a polyvalent cation, to fixate at least a portion of the infused dyeing agent; and (f) rinsing and storing the resulting dye-stabilized kiwi portion.

Another aspect of the present invention includes a method for dyeing and stabilizing a kiwi portion, or a plurality of kiwi portions, comprising the steps of: (a) immersing a kiwi portion into an acid solution that has been enriched with an ion selected from at least one of a calcium ions and a polyvalent cation, to infuse the ion through the surface of the kiwi portion to a penetrating depth of at least up to 5 mm, typically at least 1 mm and up to 3 mm; (b) immersing the ion-infused kiwi portion into an alkaline solution to adjust the penetrated surface of the kiwi portion to an alkaline pH; (c) immersing the alkaline pH kiwi portion into an alkaline solution containing a dyeing agent and a stabilizing agent, and infusing the dyeing agent and the stabilizing agent through the surface of the kiwi portion to a penetrating depth of at least up to 5 mm, typically at least 1 mm and up to 3 mm; (d) immersing the dyeing agent- and stabilizing agent-infused kiwi portion into an acidic solution to adjust the penetrated surface of the kiwi portion to an acidic pH, thereby fixating at least a portion of the infused dyeing agent and the infused stabilizing agent with the infused ion; and (e) rinsing and storing the resulting dye-stabilized kiwi portion.

A further aspect of the present invention provides that the pH level of the alkaline solution containing the stabilizing agent and/or the dyeing agent is from about 7 to 13.

A further aspect of the present invention provides that the pH level of the acid solution is from about 2 to 7.

The ion for fixating the stabilizing agent or dyeing agent is a polyvalent cation, which is typically calcium but can also be another polyvalent cations, and can be a single ion species or a mixture of different ion species.

A further aspect of the present invention provides that the pH level of the penetrated portion of the kiwi portion during the immersing of the kiwi portion into an alkaline solution is from about 7 to 13.

A further aspect of the present invention provides that the pH level of penetrated portion of the kiwi portion during the immersing of the kiwi portion into an acid solution is from about 2 to 7.

A further aspect of the present invention provides that the kiwi is selected from the group consisting of a fresh kiwi or portion thereof, a frozen kiwi or portion, and an individually quick-frozen (IQF) kiwi fruit portion.

A further aspect of the present invention provides that the stabilizing agent is selected from the group consisting of alginic acid and a salt, the salt thereof selected from the group consisting of sodium, potassium, ammonium, and propylene glycol; gellan gum; a calcium reactive pectin, the pectin selected from the group consisting of low-ester pectin, high-ester pectin (useful under the hydrolysis conditions of the alkaline solution), and amidated pectin; carrageenan, the carrageenan selected from the group consisting of iota and kappa forms and its salt, the salt thereof selected from the group consisting of ammonium, potassium, and sodium; and carboxymethyl cellulose; and mixtures thereof.

A further aspect of the present invention provides that the dyeing agent is selected from the group consisting of chlorophyllin, curcumin and norbixin.

A further aspect of the present invention provides that the polyvalent cation is selected from the group consisting of aluminum, tin, iron, copper, nickel, zinc, and magnesium.

Another aspect of the present invention includes that a subsequent process to preserve and extend the shelf life of the kiwi portion, and that the subsequent processes to preserve and extend the shelf life is selected from the group consisting of pasteurization, ultra high pressure treatment, freezing, vacuum, chemical or osmotic inhibition, and irradiation.

A further aspect of the present invention is a dye- or color-stabilized kiwi portion or portions, consisting of a kiwi portion comprising a surface portion to a depth of at least up to 5 mm, and typically 1-3 mm, wherein the surface portion comprises a dyeing agent, a stabilizing agent, and an ion selected from at least one of a calcium ions and a polyvalent cation as a fixating agent for the stabilizing agent and the dyeing agent. The stabilized, dyed kiwi portion can include one(s) made by the method of the present invention.

### DETAILED DESCRIPTION OF THE INVENTION

### A. Pulp Exposure

The desired level of ripeness for the process disclosed on the invention is that which renders the most intense flavor attributes and aptness for direct consumption. Customary processes for the industrial preconditioning of the fruits are recommended, including selection, washings, removal of stems and leaves, etc. The kiwi are peeled to remove the skin and/or cut to allow the direct exposure of the pulp to the coloring/dyeing, stabilizing and fixing agents. Preferable, peeled kiwi slices are used for further processing.

### B. Alkalinizing, Stabilizing and Dyeing

The kiwi pieces can be alkalinized in a certain way in which many of its attributes, like flavor/aroma and texture are not affected. Thus, after peeling and cutting, the kiwi portions or slices are alkalinized. This process typically takes place simultaneously with the dye stabilizing process, although a separate alkalization step employing a separate alkalinizing solution can be used. The alkalinizing stabilizing solution can be used in a weight ratio between 10:1 and 0.8:1 (solution to fruits), preferably between 2:1 and 1:1 and most preferably of 1.1:1.

The alkalinization is provided by a suitable alkalizing agent, which can be of organic or inorganic nature. Examples of suitable alkalizing agents are (but not limited to): sodium hydroxide, potassium hydroxide, calcium carbonate, sodium carbonate, magnesium hydroxide, ammonium hydroxide, amides, and their mixtures. More preferred alkalinizing agents are: sodium hydroxide, potassium hydroxide and ammonium hydroxide. Preferably, the alkalinization takes place so that the pH of the pulp is between 7-13, with pH 8-11 being preferable. In the most preferred embodiment, the pH of the pulp is 9.5 to 10.5. The infusion under this alkaline condition of certain hydrocolloids forms gels in acidic conditions and/or in presence of polyvalent cations like calcium (gelling stabilizing), can restore or maintain the texture of the fruit and add or maintain their firmness and hardness, even in high temperature conditions like pasteurization or after freezing and thawing cycles like in the IQF kiwi. The alkaline solution containing the hydrocolloids can infuse through the surface and into the outer structure of the kiwi portion to a depth at least up to about 5 mm or more, and more typically at least 1 mm and up to 3 mm.

Examples of such gelling stabilizing agents are (but not limited to): alginic acid and its salts (sodium, potassium, ammonium and propylene glycol), gellan gum, calcium reactive pectins (low-ester pectin, high-ester pectin, and amidated pectin), carrageenans (iota and kappa forms) and its salts (ammonium, potassium, or sodium) and carboxymethyl cellulose. Preferably, the alkalinization takes place so that the pH of the penetrated kiwi pulp (that is, the pulp proximate the surface of the kiwi through which the alkaline solution penetrates) is between 7-13, with pH 8-11 being preferable. In the most preferred embodiment, the pH of the penetrated pulp is 9.5 to 10.5

Preferably, the amount of gelling stabilizing agents by weight in the alkalinizing stabilizing solution is between 0.005% and 5%, more preferably 0.01% and 2%, and in the most preferred embodiment 0.02% and 1%.

The gelling stabilizing agents can be added in combination with other secondary thickeners, stabilizers, and/or gelling agents to increase the firmness of the fruit. The said secondary stabilizing agents may include vegetable, algal and microbiological hydrocolloids like agar-agar, carrageenan, processed eucheuma seaweed, arabinogalactan, cassia gum, locust bean gum, oat gum, guar gum, tragacanth, acacia gum, xanthan gum, karaya gum, tara gum, gum ghatti, glucomannan, and pectins.

Also, complex carbohydrates like starches, modified starches and modified cellulose polymers like methyl cellulose, ethyl cellulose, hydroxypropyl cellulose, hydroxy propyl methyl cellulose, ethyl methyl cellulose, carboxymethyl cellulose, sodium carboxy methyl cellulose and enzymically hydrolysed carboxymethyl cellulose can be used as secondary thickeners, stabilizers, and/or gelling agents.

Under the alkaline condition, copper complexes of chlorophyllin and optionally curcumin and norbixin can be infused into the penetrated pulp. The alkaline solution containing the dyeing agent can infuse through the surface and into the outer structure of the kiwi to a depth at least up to about 5 mm or more, and more typically at least 1 mm and up to 3 mm. After exposure of the alkalinized and dyed fruit to acidic conditions or to polyvalent cations like calcium, a kiwi portion having a stabilized and non-bleeding natural green color can be obtained.

Copper complexes of chlorophyllin, curcumin and norbixin are soluble and stable under alkaline conditions but precipitate in presence of acids and/or polyvalent cations like calcium.

Preferably, the dyeing takes place so that the color intensity of the alkalinizing dyeing solution is between 0.01 and 1, with 0.05 to 0.8 being preferable. In the most preferred embodiment, the color intensity of the alkalinizing dyeing solution is 0.1 to 0.5. Color intensity is defined as the absorbance of a 1% alkalinized solution (pH>8) in distilled water, at the wavelength of maximum absorbance for the colorant (λ_{max copper chlorophyllin}=405 nm, λ_{max curcumin}=425 nm, λ_{max norbixin}=453 nm).

The temperature of the alkalinizing stabilizing dyeing processes should be as low as possible to avoid damage to the fruit. Preferably, temperature range is between 0° C. and 40° C., more preferably between 4° C. and 25° C. and most preferred between 6° C. and 12° C.

The length of the alkaline step depends on the ripeness of the kiwi, the temperature of the solution and the desired final color. Preferably, time range of exposure is between 20 min and 24 hours, preferably between 1 and 8 hours and most preferably between 2 and 4 hours. The order of the addition of the components (stabilizing agents, dyes, etc) of the alkaline solutions is not relevant, provided that the complete solubility of the dyes and the stabilizing agents are guaranteed. The dyeing agent can be infused before or after the stabilizing agent in the same or a different solution.

### C. Fixation

Once the infusion of the dyeing agent and/or stabilizing agent has been finished, the infusion-treated kiwi pieces or portions are immersed in a fixing acid solution containing certain substances including polyvalent cations, which facilitate the precipitation of the soluble dyes and the gelling of the stabilizing agent.

This fixing acid solution should be used in a weight ratio between 10:1 and 0.8:1 (solution to fruits), preferably between 3:1 and 1:1 and most preferably of 2:1.

The gelling stabilizing agents and dyes infused into the fruit during the alkaline step are fixed by the acid present in the fixing acid solution. The acid condition allows the formation of gels and precipitation of the dyes. The acid conditions are provided by means of suitable inorganic and/or organic acids including: hydrochloric acid, sulphuric acid, phosphoric acid, nitric acid, citric acid, fumaric acid, acetic acid, tartaric acid, malic acid, oxalic acid, tannic acid, benzoic acid, propionic acid, lactic acid, ascorbic acid, etc. Among these the following are preferred: ascorbic acid, citric acid, lactic acid, malic acid and tartaric. Preferably, the acidification takes place so that the pH of the pulp is between 2-7, with pH 3-5 being preferable. In the most preferred embodiment, the pH of the pulp is 3 to 4.

The gelling stabilizing agents and dyes infused into the fruit during the alkaline step further are fixed by polyvalent cations in the acid solution that allows the formation of gels and precipitation of the dyes. At least a portion, and up to all, of the stabilizing agents and dyeing agents are fixed. The rheological property of the gel formed by the stabilizing agents and the color distribution and hue of the precipitated dyes depends on the type of polyvalent cation, their concentration and on the combinations of the cations used. Preferably, calcium is used as the main gelling/fixing polyvalent cation because it allows obtaining gels with satisfactory rheological properties and a homogeneous green color. Other suitable polyvalent cations are (but not limited to): aluminum, tin, iron, copper, nickel, zinc or magnesium.

Preferably, polyvalent cation salts are those in the forms of citrates, lactates, malates, propionates, chlorides, etc. Most preferred are calcium lactates and chlorides. Hardness (express as calcium) target values are between 100-20,000 ppm, preferably between 1,000-10,000 ppm and most preferably between 2,000-8,000 ppm.

The temperature of the fixing processes should be as low as possible to avoid damage of the fruit. Preferably, temperature range is between 0° C. and 40° C., more preferably between 4° C. and 25° C. and most preferred between 6° C. and 12° C.

Preferably, time range of exposure to the fixing acid solution is between 20 min and 24 hours, preferably between 1 and 8 hours and most preferably between 2 and 4 hours.

The order of the addition of the components of the fixing solution is not relevant. The acid could be added first, and then the cation donors, or vice versa, or they also could be added simultaneously. Optionally, calcium ions and/or polyvalent cations can be infused into the kiwi pieces prior the infusion of the stabilizing and dyeing agents.

Optionally, calcium ions and/or polyvalent cations can be infused into the kiwi prior to the infusion of the stabilizing and dyeing agents. Also optionally, either the stabilizing agents or the dyeing agent can be infused, followed by the acid fixing solution, and followed again by the other of the stabilizing agent or dyeing agent. To prevent premature fixation of the stabilizing agent or dyeing agent that are infused after an acid solution and/or polyvalent cations have been infused, the fruit should be immersed into an alkaline solution to adjust the penetrated surface to an alkaline pH, before then infusing the stabilizing agent or dyeing agent.

### D. Optional Auxiliary Processes

In case the stabilized kiwi pieces are canned for pasteurization or other sterilization treatment, it may be desirable to add certain additives to improve the shelf life and palatability of the preserved kiwi pieces. These optional additives could be infused during any of the processing stages or in the packing syrup. These may comprise the following:

1) Antioxidant agents, including, but not limited to: ascorbic acid and its salts, erythorbic acid and its salts, rosemary extract, flavonoids, etc.

2) Flavoring agents, including, but not limited to natural flavorings, identical to natural flavorings, artificial flavorings, fruit juices, etc.

3) Preservatives, including, but not limited to: lactic, sorbic, propionic, formic and benzoic acids and their salts (sodium, potassium, calcium, etc.) and derivatives, sulfites (in any chemical form), etc.

4) Acidity regulators including, but not limited to: lactic, citric, malic, fumaric, tartaric, succinic and ascorbic acids and its salts (sodium, potassium, ammonium, calcium, etc.), etc.

5) Sweeteners and flavor enhancers including, but not limited to: acesulfame potassium, aspartame, isomalt, isomaltitol, saccharin and its sodium, potassium and calcium salts, sucralose, alitame, thaumatin, glycyrrhizin, neohesperidine dihydrochalcone, stevioside, neotame, lactitol, xylitol, mannitol, glycerol, sucrose, fructose, honey, etc.

6) Firming agents including, but not limited to: calcium, magnesium or aluminum organic or inorganic salts like calcium hydrogen sulfite, monocalcium citrate, dicalcium citrate, calcium citrate (tricalcium citrate), monocalcium phosphate, dicalcium phosphate, tricalcium phosphate, calcium chloride, magnesium chloride, magnesium sulfate, aluminium sulphate, aluminum sodium sulphate, calcium gluconate, etc.

7) Optional dyes can include, but are not limited to: synthetic dyes like, FD&C Blue N^{o} 1 (Brilliant Blue FCF E133), FD&C Blue N^{o} 2 (Indigotine E132), FD&C Green N^{o} 3 (Fast Green FCF E143), FD&C Yellow N^{o} 5 (Tartrazine, E102), FD&C Yellow N^{o} 6 (Sunset Yellow FCF, E102), etc., and natural dyes like, magnesium or copper complexes of chlorophyllin, gardenia blue, gardenia yellow, carthamus, saffron, riboflavin, betacarotene, lutein, caramel, etc. Soluble colors may be added advantageously to the packing media to adjust the hue in situations when non-bleeding attributes are not essential or necessary.

### E. Preservation Processes

Several preservation options are available to get an acceptable shelf life for the final product. Alternatives are: pasteurization, high pressure treatments, freezing, vacuum, chemical or osmotic inhibition and irradiation or any other means to stop microbiologic spoilage. Most preferred methods are pasteurization and high pressure pasteurization or processing (HPP).

### EXAMPLES

The present invention is furthered explained in detail in the following Examples. However, the invention is not limited to these Examples.

### Example 1

Ten (10) kg of ripe kiwi fruit were selected using the criteria of flavor, and then were peeled and sliced in rounds of approximately 5 mm width.

An alkalinizing, stabilizing, dyeing solution containing the dyeing agent and stabilizing agent was prepared according to the following table:

TABLE 1
Alkalinizing, stabilizing, dyeing solution:

| Ingredient | Quantity (grams) |
|---|---|
| Soft Water | 10,478.00 |
| Low Ester Pectin | 20.00 |
| Copper Chlorophyllin 90% | 2.00 |
| Ammonium Hydroxide | 500.00 |

The alkalinizing stabilizing dyeing solution was cooled to a temperature below 12° C. The kiwi pieces were immersed in the alkalinizing stabilizing dyeing solution in a weight ratio of 1.1:1 (solution to fruits) and were left there for 3 hours.

A fixing acid solution was prepared according to the following table:

TABLE 2
Fixing acid solution:

| Ingredient | Quantity (grams) |
|---|---|
| Soft Water | 18,800.00 |
| Ascorbic acid | 200.00 |
| Calcium lactate | 1,000.00 |

Once the alkaline process was finished, the kiwi pieces were immersed in the fixing acid solution in a weight ratio of 2:1 (solution to fruits) that was kept at a temperature below 12° C., for 3 hours.

The kiwi pieces were then rinsed with clean water and packing syrup was prepared according to the table 3:

TABLE 3
Packing solution:

| Ingredient | Quantity (grams) |
|---|---|
| Soft Water | 15,000.00 |
| Sucrose | 5,000.00 |

The fruits were immersed in suitable recipients with the packing syrup, in a weight ratio of 2:1 (solution to fruits).

The fruits in the packing syrup were pasteurized at 95° C. for 10 minutes.

In a first stability evaluation, after allowing the solution to cool, the kiwi pieces were evaluated in their sensory features. The color was brilliant, homogeneous, and very similar to the natural one; the firmness and texture was adequate and resembled that of the ripe fruit; the flavor profile was according with the expected quality.

### Example 2

### Control Trial: Untreated Kiwi Slices

Unprocessed kiwi is used for control parameters.

### DESCRIPTION OF THE SENSORY TESTS

Firmness: Measured with a fruit pressure tester (also known as penetrometer) using a 11.3 mm diameter plunger.

Texture: The texture was tested by an expert panel, with a qualitative scale from 1 to 5, being 5 the more similar texture to the fresh ripe fruit and 1 the less similar.

Color: The external color of the surface of the kiwi portions was determined using a Hunter Lab instrument.

Flavor and aroma: The flavor and aroma were tested by an expert panel; with a qualitative scale from 1 to 5, being 5 the more similar flavor profile to the fresh ripe fruit and 1 the less similar.

Bleeding: Measured by determination of the direct absorbance of the syrup with a Shimadzu Mini UV 1240 spectrophotometer at 520 nm wavelength using a lcm square cell.

The compared results of the sensory tests are shown in the next tables.

TABLE 4
Sensory results before Pasteurization: Comparison of the Disclosed
Method to untreated kiwi pieces

| | | | Color | Flavor/ | Bleeding |
|---|---|---|---|---|---|
| | Firmness | Texture | (Lab space) | Aroma | (absorbance at |
| Example | (kg) | (1-5) | L, a, b | (1-5) | 405 nm) |
| 1 | 6 | 3 | 49/−4/27 | 3 | 0 |
| 2 | 8 | 5 | 41/−8/17 | 5 | 0 |

TABLE 5
Sensory results after Pasteurization: Comparison of the
Disclosed Method to untreated kiwi pieces

| | | | Color | Flavor/ | Bleeding |
|---|---|---|---|---|---|
| | Firmness | Texture | (Lab space) | Aroma | (absorbance at |
| Example | (kg) | (1-5) | L, a, b | (1-5) | 405 nm) |
| 1 | 7 | 5 | 40/−7/20 | 4 | 0 |
| 2 | 0 | 1 | 52/−1/28 | 1 | 0 |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method for dyeing and stabilizing a kiwi portion, or a plurality of kiwi portions, comprising the steps of: (a) immersing a kiwi portion in an alkaline solution containing a stabilizing agent and a dyeing agent, and infusing the stabilizing agent and dyeing agent through the surface of the kiwi portion to a penetrating depth of up to 5 mm, typically at least 1 mm and up to 3 mm; (b) immersing the alkaline-treated kiwi portion into an acid solution that has been enriched with an ion selected from at least one of a calcium ions and a polyvalent cation, to fixate the infused stabilizing agent and dyeing agent; and (c) rinsing and storing the resulting dye-stabilized kiwi portion.

2. A method for dyeing and stabilizing a kiwi portion, comprising the steps of: (a) immersing a kiwi portion in an alkaline solution containing a stabilizing agent, and infusing the stabilizing agent through the surface of the kiwi portion to a penetrating depth of up to 5 mm, typically at least 1 mm and up to 3 mm; (b) immersing the stabilizing agent-infused kiwi portion in an alkaline solution containing a dyeing agent, and infusing the dyeing agent through the surface of the kiwi portion to a penetrating depth of up to 5 mm, typically at least 1 mm and up to 3 mm; (c) immersing the stabilizing agent and dyeing agent-infused kiwi portion in an acid solution that has been enriched with an ion selected from at least one of a calcium ions and a polyvalent cation, to fixate at least a portion of the stabilizing agent and dyeing agent; and (d) rinsing and storing the resulting dye-stabilized kiwi portion.

3. A method for dyeing and stabilizing a kiwi portion, comprising the steps of: (a) immersing a kiwi portion in an alkaline solution containing a dyeing agent, and infusing the dyeing agent through the surface of the kiwi portion to a penetrating depth of up to 5 mm, typically at least 1 mm and up to 3 mm; (b) immersing the dyeing agent-infused kiwi portion in an alkaline solution containing a stabilizing agent, and infusing the stabilizing agent through the surface of the kiwi portion to a penetrating depth of up to 5 mm, typically at least 1 mm and up to 3 mm; (c) immersing the stabilizing agent and dyeing agent-infused kiwi portion in an acid solution that has been enriched with an ion selected from at least one of a calcium ions and a polyvalent cation, to fixate at least a portion of the stabilizing agent and dyeing agent; and (d) rinsing and storing the resulting dye-stabilized kiwi portion.

4.-6. (canceled)

7. The method of claim 1 wherein the kiwi is selected from the group consisting of a fresh kiwi, a frozen kiwi, and an individually quick-frozen (IQF) kiwi fruit

8. The method of claim 1, wherein the stabilizing agent is selected from the group consisting of alginic acid and a salt, the salt thereof selected from the group consisting of sodium, potassium, ammonium, and propylene glycol; gellan gum; a calcium reactive pectin, the pectin selected from the group consisting of low-ester pectin and amidated pectin; carrageenan, the carrageenan selected from the group consisting of iota and kappa forms and its salt, the salt thereof selected from the group consisting of ammonium, potassium, and sodium; and carboxymethyl cellulose; and mixtures thereof.

9. The method of claim 1 wherein the dyeing agent is selected from the group consisting of chlorophyllin, curcumin and norbixin, and mixtures thereof.

10. The method of claim 1 wherein the pH level of the alkaline solution containing the stabilizing agent and/or the dyeing agent is from about 7 to 13.

11. The method of claim 1 wherein the pH level of the acid solution is from about 2 to 7.

12. The method of claim 1 wherein the polyvalent cation is selected from the group consisting of aluminum, tin, iron, copper, nickel, zinc, magnesium, and mixtures thereof.

13. The method of claim 1, further including a subsequent process to preserve and extend the shelf life of the resulting kiwi portion.

14. The method of claim 13 wherein the subsequent processes to preserve and extend the shelf life is selected from the group consisting of pasteurization, ultra high pressure treatment, freezing, vacuum, chemical or osmotic inhibition, and irradiation.

15.-23. (canceled)

24. The method of claim 2, wherein the stabilizing agent is selected from the group consisting of alginic acid and a salt, the salt thereof selected from the group consisting of sodium, potassium, ammonium, and propylene glycol; gellan gum; a calcium reactive pectin, the pectin selected from the group consisting of low-ester pectin and amidated pectin; carrageenan, the carrageenan selected from the group consisting of iota and kappa forms and its salt, the salt thereof selected from the group consisting of ammonium, potassium, and sodium; and carboxymethyl cellulose; and mixtures thereof.

25. The method of claim 2 wherein the dyeing agent is selected from the group consisting of chlorophyllin, curcumin and norbixin, and mixtures thereof

26. The method of claim 2 wherein the polyvalent cation is selected from the group consisting of aluminum, tin, iron, copper, nickel, zinc, magnesium, and mixtures thereof.

27. The method of claim 2 wherein the pH level of the alkaline solution containing the stabilizing agent and/or the dyeing agent is from about 7 to 13.

28. The method of claim 2 wherein the pH level of the acid solution is from about 2 to 7.

29. The method of claim 3, wherein the stabilizing agent is selected from the group consisting of alginic acid and a salt, the salt thereof selected from the group consisting of sodium, potassium, ammonium, and propylene glycol; gellan gum; a calcium reactive pectin, the pectin selected from the group consisting of low-ester pectin and amidated pectin; carrageenan, the carrageenan selected from the group consisting of iota and kappa forms and its salt, the salt thereof selected from the group consisting of ammonium, potassium, and sodium; and carboxymethyl cellulose; and mixtures thereof.

30. The method of claim 3 wherein the dyeing agent is selected from the group consisting of chlorophyllin, curcumin and norbixin, and mixtures thereof, and the polyvalent cation is selected from the group consisting of aluminum, tin, iron, copper, nickel, zinc, magnesium, and mixtures thereof.

31. The method of claim 3 wherein the pH level of the alkaline solution containing the stabilizing agent and/or the dyeing agent is from about 7 to 13.

32. The method of claim 3 wherein the pH level of the acid solution is from about 2 to 7.
